(19) United States
(12) Patent Application Publication
(10) Pub. No.: US 2015/0033342 A1
(43) Pub. Date: Jan. 29, 2015

(54) SECURITY DETECTION METHOD AND SYSTEM

(71) Applicant: BEIJING NETQIN TECHNOLOGY CO., LTD., Beijing (CN)

(72) Inventors: Jun Zhang, Beijing (CN); Yu Lin, Beijing (CN); Shihong Zou, Beijing (CN); Wenyong Shi, Beijing (CN)

(21) Appl. No.: 14/379,461

(22) PCT Filed: Mar. 13, 2013
(86) PCT No.: PCT/CN2013/072534

§ 371 Date: Aug. 18, 2014

(30) Foreign Application Priority Data
Apr. 28, 2012 (CN) 201210129377.8

(51) Int. Cl. H04L 29/06

(52) U.S. Cl. CPC H04L 63/1416
USPC 726/23

(57) ABSTRACT

Disclosed are a security detection method and system. The method comprises: (a) performing security scanning on code of an application program; if a high risk is detected, marking the application program as a high risk application program, generating a detection result, and performing step (d); otherwise, performing step (b) (S110); (b) analyzing the code of the application program and generating an analysis result (S120); (c) performing detection determining based on the analysis result to determine security of the application program, and generating a detection determining result (S130); and (d) storing the detection result or the detection determining result and form security level data (S140). The system comprises a vulnerability detection module, an analysis module, a detection determining module, and a database. According to this embodiment, a malicious application program can be rapidly found from a great number of application programs and a risk level of the application program can be provided, so as to enable a user to easily know the high risk application program and avoid using it, thereby reducing the loss and regulating application markets.

### CROSS-REFERENCE TO RELATED APPLICATION(S)

This application is a U.S. National Phase Application of International Application No. PCT/CN2013/072534, filed on Mar. 13, 2013, entitled “SECURITY DETECTION METHOD AND SYSTEM,” which claims priority to Chinese Application No. 201210129377.8, filed on Apr. 28, 2012, both of which are incorporated herein by reference in their entirety.

### TECHNICAL FIELD

The present disclosure relates to the field of the mobile device technology, and in particular, to a security detection method and system.

### BACKGROUND

With the development of the smart phone technology, more and more App application programs are developed for smart phones. However, for many existing App applications, there are a lot of potential safety risks during the use of the Apps, e.g., unauthorized charging, traffic consumption, and theft of privacy information, such as, SMS, address book, geographic locations, or the like. The present technologies for detecting whether App applications are safe or not cannot meet the requirements of App application security.

### SUMMARY

In view of this, the object of the present disclosure is to provide a security detection method and system, so as to solve a technical problem that a malicious application program cannot be rapidly found from a great number of App applications. Moreover, the present disclosure may solve technical problems of performing risk assessment on application programs and grading a risk.

Therefore, the present disclosure provides a security detection method, which comprises steps of:
(a). performing security scanning on code of an application program; if a high risk is detected, indicating that the application program is a high risk application program, generating a detection result, and performing step (d); otherwise, performing step (b);
(b). analyzing the code of the application program, and generating an analysis result;
(c). performing detection determining based on the analysis result to determine security of the application program, and generating a detection determining result; and
(d). storing the detection result or the detection determining result to form security level data.

According to the above method, wherein the security scanning scans the code of the application program by means of a high risk detection logic to detect the high risk application program.

The high risk detection logic is an approach of performing security detection on the application program by utilizing a high risk feature code library.

According to the above method, wherein the step (b) further comprises:
(b1). pre-processing the code of the application program to extract binary code from the code, and converting the binary code into an intermediate code representation; and
(b2). performing control flow analysis and data flow analysis based on the intermediate code representation and generating the analysis result.

According to the above method, wherein the step (b2) comprises:
performing control flow analysis based on the intermediate code representation to obtain a function call graph, which accurately expresses mutual call relationships among respective functions in the code of the application program; and
performing further control flow analysis on the intermediate code representation with reference to the data flow analysis, and correcting the analysis result which comprises the function call graph.

According to the above method, wherein the step (c) further comprises:
(c1). performing the detection determining on the application program by means of a moderate risk detection logic; if a moderate risk is detected, marking the application program as a moderate risk application program and performing step (c4); otherwise, performing step (c2);
(c2). performing the detection determining on the application program by means of a suspicious behavior detection logic; if a suspicious behavior is detected, marking the application program as a suspicious application program and performing step (c4); otherwise, performing step (c3);
(c3). marking the application program, which has passed the detection determining, as a normal application program; and
(c4). forming the detection determining result.

According to the above method, wherein the moderate risk detection logic is an approach of performing security detection on the application program by utilizing a risk feature library.

According to the above method, wherein the suspicious behavior detection logic is an approach of performing security detection on the application program by utilizing a suspicious behavior rule library.

The present disclosure further provides a security detection system, the system comprising:
a vulnerability detection module configured to perform security scanning on code of an application program; if a high risk is detected, mark the application program as a high risk application program, generate a detection result, and send the detection result to a database; otherwise, send the code of the application program to an analysis module;
the analysis module configured to pre-process the code of the application program, perform further control flow analysis and data flow analysis, generate an analysis result, and submit the analysis result to a detection determining module;
the detection determining module configured to perform detection determining on security of the application program based on the analysis result, generate a detection determining result, and send the detection determining result to the database; and
the database configured to store the detection result or the detection determining result to form security level data.

According to the above method, wherein the vulnerability detection module comprises:
a high risk detection logic unit configured to detect the code of the application program by utilizing a high risk feature code library, mark a detected high risk application program, and generate a detection result; and
a sending unit configured to send the detection result generated by the high risk detection logic unit to the database, and send the code of the application program, which has passed the detection, to the analysis module.

According to the above method, wherein the analysis module comprises:
a pre-processing sub-module configured to pre-process the code of the application program to extract binary code from the code, convert the binary code into an intermediate code representation, and send the intermediate code representation to a flow analysis sub-module; and
the flow analysis sub-module configured to perform control flow analysis and data flow analysis based on the intermediate code representation, generate the analysis result, and send the analysis result to the detection determining module.

According to the above method, wherein the flow analysis sub-module comprises:
a control flow analysis unit configured to perform control flow analysis based on the intermediate code representation, generate a function call graph accurately expressing mutual call relationships among respective functions in the code of the application program, correct the analysis result with reference to the data flow analysis, the analysis result including the function call graph; and
a data flow analysis unit configured to perform the data flow analysis on the application program on basis of the control flow analysis.

According to the above method, wherein the detection determining module comprises:
a moderate risk detection logic unit configured to perform the detection determining on the application program by means of a moderate risk detection logic; if a moderate risk is detected, mark the application program as a moderate risk application program;
a suspicious behavior detection logic unit configured to perform the detection determining on the application program by means of a suspicious behavior detection logic; if a suspicious behavior is detected, marking the application program as a suspicious application program;
a normality marking unit configured to mark the application program, which has passed the detection determining, as a normal application program; and
a sending unit configured to send the detection determining result to the database.

According to the above system, wherein the moderate risk detection logic is an approach of performing a security detection on the application program by utilizing a risk feature library.

According to the above system, wherein the suspicious behavior detection logic is an approach of performing a security detection on the application program by utilizing a suspicious behavior rule library.

With the security detection method and system provided in accordance with embodiments of the present disclosure, a malicious application program can be rapidly found from a great number of application programs and a risk level of the application program can be provided, so as to enable a user to easily know the risk level of the application program and to avoid using high risk applications, thereby reducing the loss and regulating application markets.

### BRIEF DESCRIPTION OF THE DRAWINGS

To illustrate embodiments of the present disclosure or solutions of prior art in a clearer manner, brief introductions will be given below with respect to the figures to be used in the descriptions of the embodiments or prior art. It is obvious that the figures in the following descriptions are merely some embodiments of the present disclosure. For one ordinarily skilled in the art, other figures may be derived, without any inventive efforts, from these figures in which:

FIG. 1 is a flow chart of a security detection method in accordance with an embodiment of the present disclosure;

FIG. 2 is a process flow chart of a security detection method in accordance with an embodiment of the present disclosure;

FIG. 3 is a flow chart of a method of analyzing an application program in accordance with an embodiment of the present disclosure;

FIG. 4 is a structural block diagram of a security detection system in accordance with an embodiment of the present disclosure;

FIG. 5 is a structural block diagram of a vulnerability detection module in the system as shown in FIG. 4;

FIG. 6 is a structural block diagram of an analysis module in the system as shown in FIG. 4;

FIG. 7 is a structural block diagram of a flow analysis sub-module in the structure as shown in FIG. 6; and

FIG. 8 is a structural block diagram of a detection determining module in the system as shown in FIG. 4.

### DETAILED DESCRIPTION

To present the objects, solutions, and advantages of the embodiments of the present disclosure in a clearer manner, detailed descriptions of the embodiments of the present disclosure will be further given below in conjunction with the figures. Here, the illustrative embodiments of the present disclosure and the description thereof are given for the purpose of illustration only, not for the purpose of limitation.

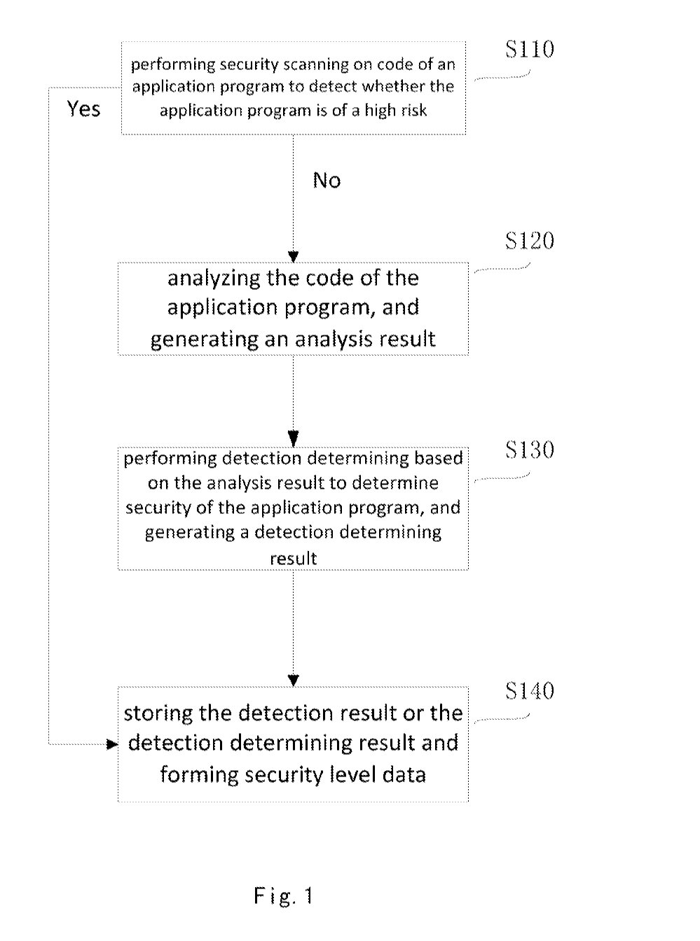

Referring to FIG. 1, an embodiment of the present disclosure provides a security detection method, which comprises the following steps:
step S110, performing security scanning on code of an application program; if a high risk is detected, indicating that the application program is a high risk application program, generating a detection result, and performing step S140; otherwise, performing step S120;
step S120, analyzing the code of the application program, and generating an analysis result;
step S130, performing detection determining based on the analysis result to determine security of the application program, and generating a detection determining result; and
step S140, storing the detection result or the detection determining result to form security level data.

According to the embodiment of the present disclosure, the application program may be any application program on a mobile device, which includes, but not limited to, a mobile phone, a tablet computer, etc. The application program may include, in terms of its security level, a high risk application program, a moderate risk application program, a suspicious application program, or a normal application program.

In an embodiment of the present disclosure, detailed descriptions will be made by taking an application program on an Android-based smart phone as an example.

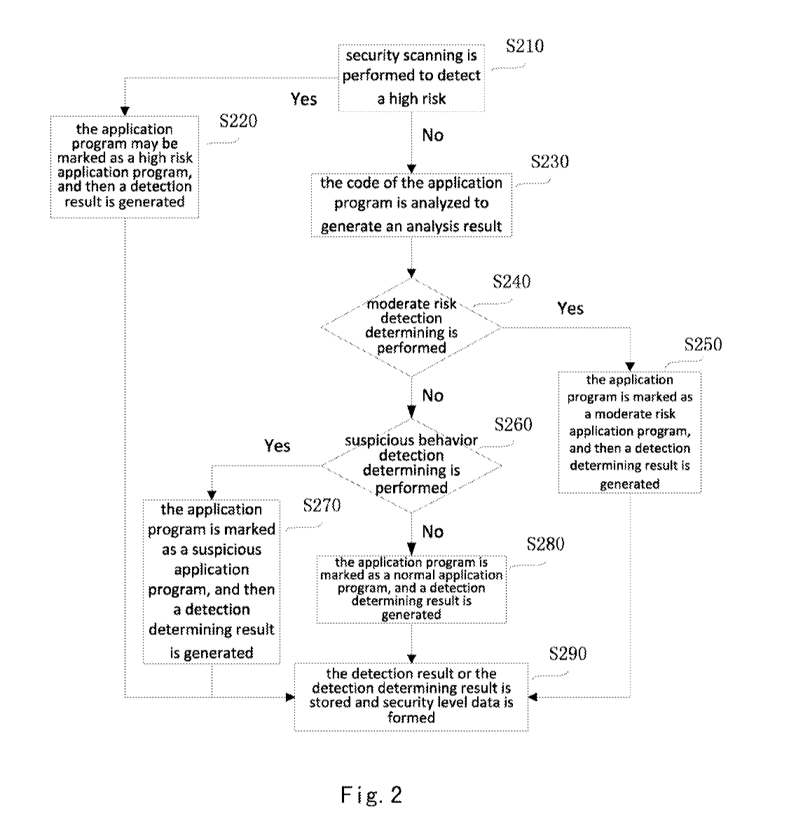

When it is needed to determine a security level of any application program, the method according to the embodiment of the present disclosure may be described with reference to FIG. 2.

At step S210, security scanning is performed on code of the application program to detect whether it is a high risk application program or not.

The security scanning scans the code of the application program by means of a high risk detection logic to detect the high risk application program. The high risk detection logic is an approach of performing security detection on the application program by utilizing a high risk feature code library.

In the practical application, the high risk feature code library may include, but not limited to, feature codes extracted based on the known vulnerabilities attacking program. For example, the feature codes may be a prompting character string, e.g., “abcd”, during a process of executing the vulnerabilities attacking program. It may be determined whether there is the character string in the application program by comparison, so as to determine a high risk of the application program.

At step S220, if the application program is of a high risk, the application program may be marked as a high risk application program, and then a detection result is generated.

At step S230, if the application program is not of a high risk, the code of the application program is analyzed to generate an analysis result.

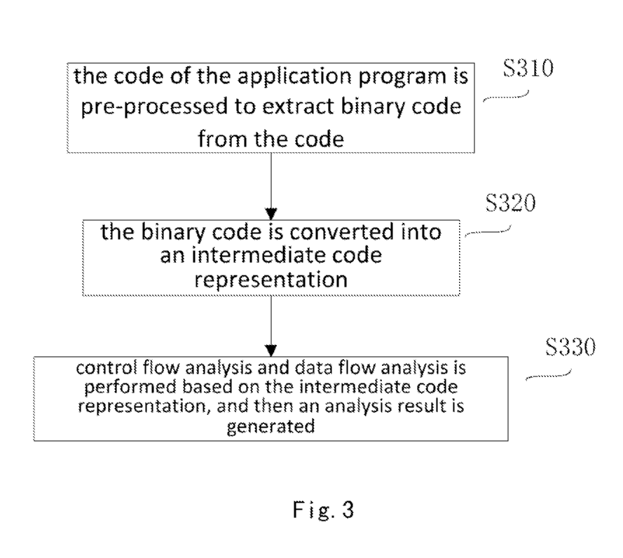

In this embodiment, the static analysis technology is usually employed to analyze the code of the application program, which is described in detail by referring to FIG. 3.

At step S310, the code of the application program is pre-processed to extract binary code from the code, and the binary code is converted into an intermediate code representation.

At step S320, the binary code is converted into an intermediate code representation.

In the practical application, the conversion of the binary code into an intermediate code representation is usually done by conversion and optimization technology.

In an Android application program, a Dalvik bytecode is firstly extracted from the application program and then converted into a Java bytecode, which is finally converted into an intermediate code representation.

At step S330, control flow analysis and data flow analysis is performed based on the intermediate code representation, and then an analysis result is generated.

In the practical application, the analysis result may include a function call graph, which is constructed based on the intermediate code representation. First of all, the function call graph may be obtained by performing control flow analysis based on the intermediate code representation. However, the function call graph is not entirely accurate.

Thereafter, the function call graph may be corrected by performing further control flow analysis on the intermediate code representation in connection with data flow analysis. The operation may be repeatedly performed until an accurate function call graph is reached. The function call graph can accurately express mutual call relationships among respective functions in the code of the application program.

At step S240, moderate risk detection determining is performed on the application program based on the analysis result.

moderate risk detection determining is performed on the application program by means of a moderate risk detection logic. The moderate risk detection logic is an approach of performing security detection on the application program by utilizing a risk feature library.

In the practical application, the risk feature library may include, but not limited to, a feature extracted based on an execution path of a known risky code. For example, the feature may be an execution path “Run, a, b, SendSMS” for the code of the application program. After executing the path, the application program would automatically send an SMS message, which may charge the user's communication fees. It may be determined whether the application program is a moderate risk application program by comparing an execution path of “Thread Run” in the application program with features in the library. If the execution path of the thread is the same as any feature in the feature library, the application program may be determined as a moderate risk application program.

In an Android application program, a moderate risk may include, but not limited to:
1. sending an SMS and/or subscribing paid services;
2. corrupting user data;
3. downloading and installing other application programs; and
4. accessing malicious/ advertising web sites, uploading user's private data, and wasting bandwidth, etc.

At step S250, if a moderate risk is detected, the application program is marked as a moderate risk application program, and then a detection determining result is generated.

At step S260, if there is no moderate risk detected, suspicious behavior detection determining is performed on the application program.

The detection determining may be performed on the application program by means of a suspicious behavior detection logic. The suspicious behavior detection logic is an approach of performing a security detection on the application program by utilizing a suspicious behavior rule library.

In the practical application, the suspicious behavior rule library may include, but not limited to, a suspicious behavior function call library extracted based on characteristics of the existing malicious programs.

In an Android application program, the suspicious behavior may include, but not limited to:
1. containing a sub-package in an installation package, e.g., embedding, into an apk, another apk or a jar package;
2. dynamically code loading, e.g., loading a jar package or apk by using DexClassLoader;
3. calling a system function related to encryption/decryption in the application program;
4. executing an external script/command, e.g., executing Runtime.exec; and/or
5. accessing Native Library by using JNI, etc.

At step S270, if a suspicious behavior is detected, the application program is marked as a suspicious application program, and then a detection determining result is generated.

At step S280, if no suspicious behavior is detected, the application program is marked as a normal application program, and a detection determining result is generated.

At step S290, the detection result or the detection determining result is stored to form security level data.

With the above steps, malicious code can be rapidly found from massive Android applications. A risk level library for App may be created by using the security level data, so as to enable a user to easily know APP's risk level, thereby regulating APP application markets and providing references for local or cloud online virus scanning and killing.

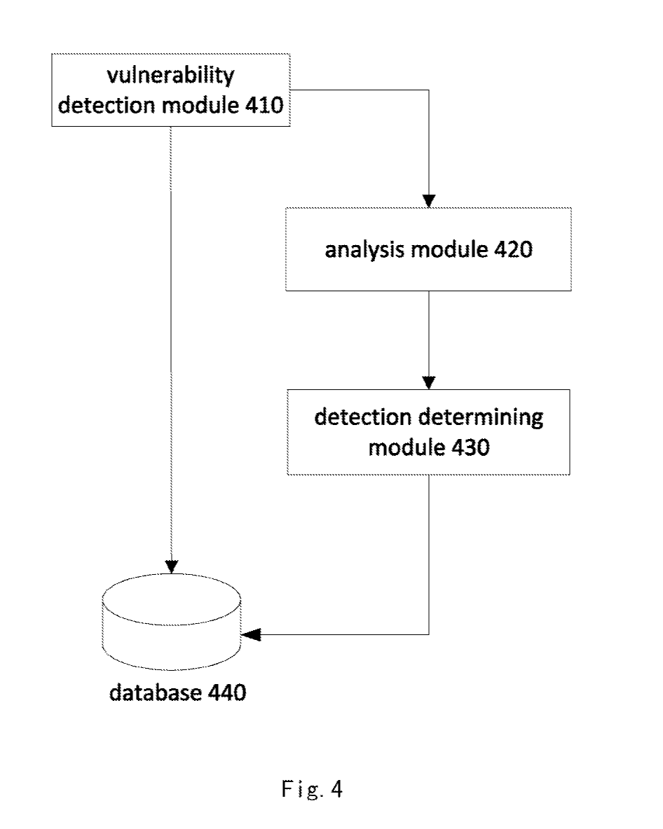

Referring to FIG. 4, an embodiment of the present disclosure provides a security detection system, which comprises:
a vulnerability detection module 410 configured to perform security scanning on code of an application program; if a high risk is detected, mark the application program as a high risk application program, generate a detection result, and send the detection result to a database 440; otherwise, send the code of the application program to an analysis module 420;
the analysis module 420 configured to pre-process the code of the application program, perform further control flow analysis and data flow analysis, generate an analysis result, and submit the analysis result to a detection determining module 430;
the detection determining module 430 configured to perform detection determining on security of the application program based on the analysis result, generate a detection determining result, and send the detection determining result to the database 440; and
the database 440 configured to store the detection result or the detection determining result and form security level data.

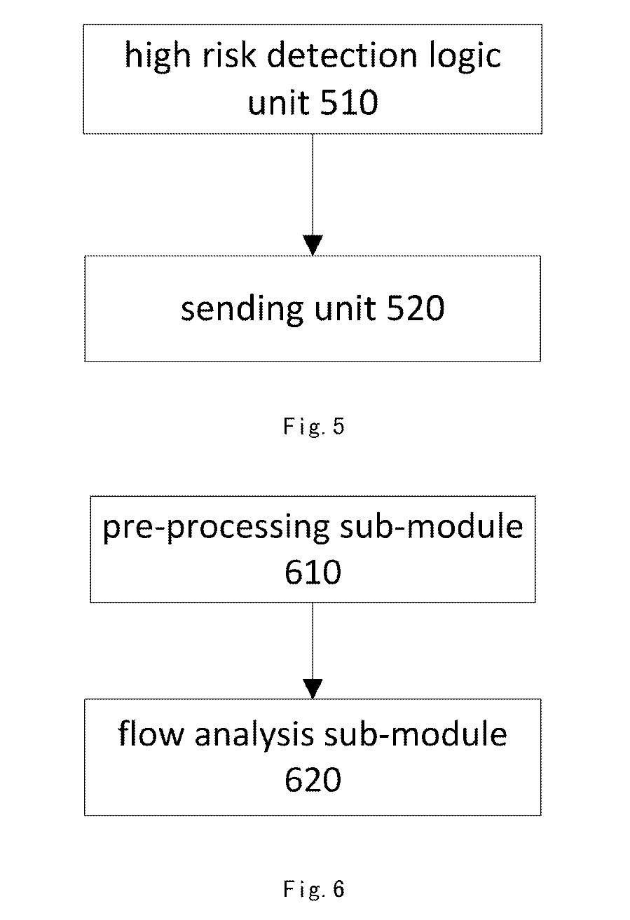

Referring to FIG. 5, according to an embodiment of the present disclosure, the vulnerability detection module 410 comprises:
a high risk detection logic unit 510 configured to detect the code of the application program by utilizing a high risk feature code library, mark a detected high risk application program, and generate a detection result; and
a sending unit 520 configured to send the detection result generated by the high risk detection logic unit 510 to the database 440, and send the code of the application program, which has passed the detection, to the analysis module 420.

Referring to FIG. 6, according to an embodiment of the present disclosure, the analysis module 420 comprise:
a pre-processing sub-module 610 configured to pre-process the code of the application program to extract binary code from the code, to convert the binary code into an intermediate code representation, and to send the intermediate code representation to a flow analysis sub-module 620; and
the flow analysis sub-module 620 configured to perform control flow analysis and data flow analysis based on the intermediate code representation, generate the analysis result, and send the analysis result to the detection determining module 430.

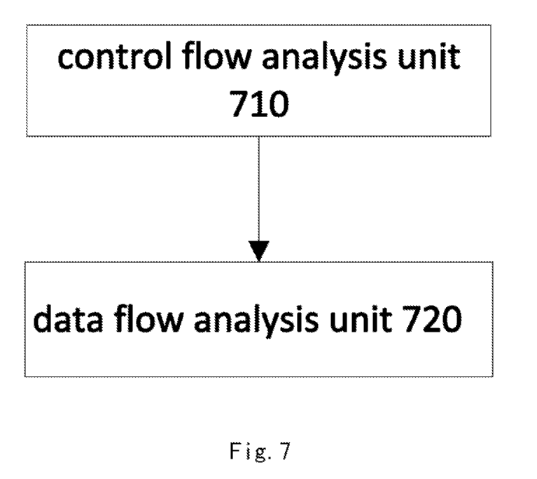

Referring to FIG. 7, according to an embodiment of the present disclosure, the flow analysis sub-module 620 comprise:
a control flow analysis unit 710 configured to perform control flow analysis based on the intermediate code representation, generate a function call graph for the application program which accurately expresses mutual call relationships among respective functions in the code of the application program, correct the analysis result with reference to the data flow analysis, the analysis result including the function call graph; and
a data flow analysis unit 720 configured to perform the data flow analysis on the application program on basis of the control flow analysis.

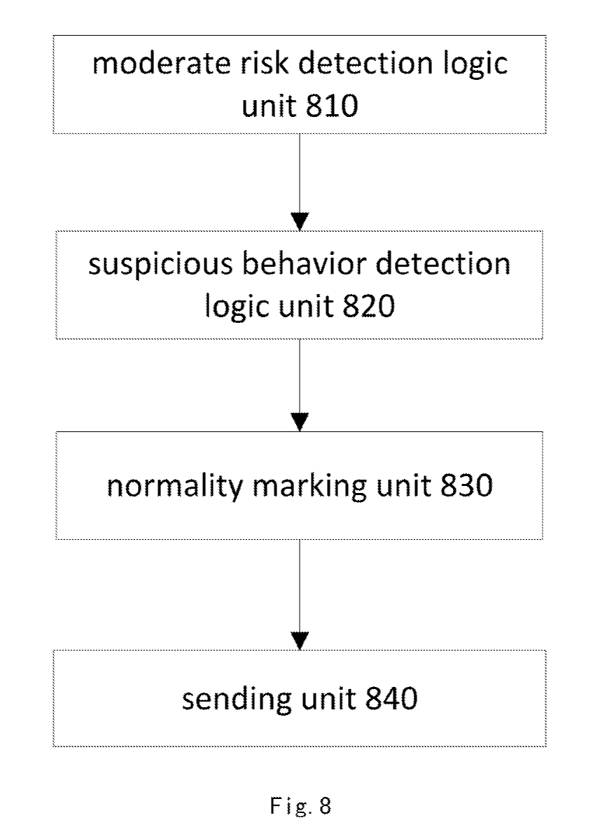

Referring to FIG. 8, according to an embodiment of the present disclosure, the detection determining module 430 comprises:
a moderate risk detection logic unit 810 configured to perform the detection determining on the application program by means of a moderate risk detection logic; if a moderate risk is detected, mark the application program as a moderate risk application;
a suspicious behavior detection logic unit 820 configured to perform the detection determining on the application program by means of a suspicious behavior detection logic; if a suspicious behavior is detected, marking the application program as a suspicious application;
a normality marking unit 830 configured to mark the application, which has passed the detection determining, as a normal application; and
a sending unit 840 configured to send the detection determining result to the database 440.

Preferably, according to an embodiment of the present disclosure, the moderate risk detection logic is an approach of performing a security detection on the application program by utilizing a risk feature library.

Preferably, according to an embodiment of the present disclosure, the suspicious behavior detection logic is an approach of performing a security detection on the application program by utilizing a suspicious behavior rule library.

Moreover, the method according to the present disclosure may be applied in any device requiring for security detection, e.g., a mobile terminal (such as a mobile phone, a PDA, a laptop computer, a tablet computer, etc), a fixed terminal (such as a desktop computer, a work station, a set-top box, etc), a network side device (such as an access point, a base station, a radio network controller, etc), and the like.

Moreover, respective modules, sub-modules, units and the like comprised by the system according to the present disclosure may be embodied by physical hardware in the above one or more devices either alone or in combination. For example, functions of the above respective modules and sub-module units may be implemented by a (micro) processor and a storage in the device in combination with a transceiver and the like device. In the present disclosure, a function described as being implemented by a single module or unit, may be implemented by multiple physical hardware, and a function described as being implemented by multiple modules or units may be implemented by a single hardware. These modifications do not go beyond the scope of the present disclosure and should be covered by the scope of the claims.

Moreover, the method, device or system as described in the present disclosure is not limited to being applied in the Android system as mentioned above. Actually, the method, device or system as described in the present disclosure may be applied in various systems, such as iOS, BlackBerry, WindowsMobile, Symbian or the like.

It should be noted that use of the terms “comprise”, “contain” or any variations thereof do not exclude the presence of elements or steps other than those stated in the disclosure, such that a process, method, item, or device comprising a series of elements not only comprises those elements, but also comprise other elements not listed explicitly, or further comprise elements that are inherent in this process, method, item, or device. Without further limitation, an element defined with a sentence “comprising one . . . ” does not exclude the situation where a process, method, item, or device comprising the element further comprises other element that is identical to the element.

The objects, solutions, and advantages of the present disclosure are further detailed by the above specific embodiments. It should be appreciated that the above descriptions are merely specific embodiments of the present disclosure and not for the purpose of limiting the scope of the present disclosure. Any modification, equivalent substitution, improvement, or the like made within the spirit and principle of the present disclosure should be embraced by the scope of the present disclosure.

1. A security detection method, characterized in that, the method comprises:
(a). performing security scanning on code of an application program; if a high risk is detected, indicating that the application program is a high risk application program, generating a detection result, and performing step (d); otherwise, performing step (b);
(b). analyzing the code of the application program, and generating an analysis result;
(c). performing detection determining based on the analysis result to determine security of the application program, and generating a detection determining result; and
(d). storing the detection result or the detection determining result and forming security level data.

2. The method according to claim 1, characterized in that, the security scanning scans the code of the application program by means of a high risk detection logic to detect the high risk application program;
wherein the high risk detection logic is an approach of performing security detection on the application program by utilizing a high risk feature code library.

3. The method according to claim 1, characterized in that, the step (b) further comprises:
(b1). pre-processing the code of the application program to extract binary code from the code, and converting the binary code into an intermediate code representation; and
(b2). performing control flow analysis and data flow analysis based on the intermediate code representation and generating the analysis result.

4. The method according to claim 3, characterized in that, the step (b2) comprises:
performing control flow analysis based on the intermediate code representation to obtain a function call graph, the function call graph accurately expressing mutual call relationships among respective functions in the code of the application program; and
performing further control flow analysis on the intermediate code representation with reference to the data flow analysis, and correcting the analysis result, the analysis result comprising the function call graph.

5. The method according to claim 1, characterized in that, the step (c) further comprises:
(c1). performing the detection determining on the application program by means of a moderate risk detection logic; if a moderate risk is detected, marking the application program as a moderate risk application program and performing step (c4); otherwise, performing step (c2):
(c2). performing the detection determining on the application program by means of a suspicious behavior detection logic; if a suspicious behavior is detected, marking the application program as a suspicious application program and performing step (c4); otherwise, performing step (c3);
(c3). marking the application, which has passed the detection determining, as a normal application; and
(c4). forming the detection determining result.

6. The method according to claim 5, characterized in that, the moderate risk detection logic is an approach of performing a security detection on the application program by utilizing a risk feature library.

7. The method according to claim 5, characterized in that, the suspicious behavior detection logic is an approach of performing a security detection on the application program by utilizing a suspicious behavior rule library.

8. A security detection system, characterized in that, the system comprises:
a vulnerability detection module configured to perform security scanning on code of an application program; if a high risk is detected, mark the application program as a high risk application program, generate a detection result, and send the detection result to a database; otherwise, send the code of the application program to an analysis module;
the analysis module configured to pre-process the code of the application program, perform further control flow analysis and data flow analysis, generate an analysis result, and submit the analysis result to a detection determining module;
the detection determining module configured to perform detection determining on security of the application program based on the analysis result, generate a detection determining result, and send the detection determining result to the database; and
the database configured to store the detection result or the detection determining result for forming security level data.

9. The system according to claim 8, characterized in that, the vulnerability detection module comprises:
a high risk detection logic unit configured to detect the code of the application program by utilizing a high risk feature code library, mark a detected high risk application program, and generate a detection result; and
a sending unit configured to send the detection result generated by the high risk detection logic unit to the database, and send the code of the application program, which has passed the detection, to the analysis module.

10. The system according to claim 8, characterized in that, the analysis module comprises:
a pre-processing sub-module configured to pre-process the code of the application program to extract binary code from the code, convert the binary code into an intermediate code representation, and send the intermediate code representation to a flow analysis sub-module; and
the flow analysis sub-module configured to perform control flow analysis and data flow analysis based on the intermediate code representation, generate the analysis result, and send the analysis result to the detection determining module.

11. The system according to claim 10, characterized in that, the flow analysis sub-module comprises:
a control flow analysis unit configured to perform control flow analysis based on the intermediate code representation, generate a function call graph for the application program which accurately expresses mutual call relationships among respective functions in the code of the application program, correct the analysis result with reference to the data flow analysis, the analysis result comprising the function call graph; and
a data flow analysis unit configured to perform the data flow analysis on the application program on basis of the control flow analysis.

12. The system according to claim 8, characterized in that, the detection determining module comprises:
a moderate risk detection logic unit configured to perform the detection determining on the application program by means of a moderate risk detection logic; if a moderate risk is detected, mark the application program as a moderate risk application;
a suspicious behavior detection logic unit configured to perform the detection determining on the application program by means of a suspicious behavior detection logic; if a suspicious behavior is detected, marking the application program as a suspicious application program;
a normality marking unit configured to mark the application, which has passed the detection determining, as a normal application; and
a sending unit configured to send the detection determining result to the database.

13. The system according to claim 12, characterized in that, the moderate risk detection logic is an approach of performing a security detection on the application program by utilizing a risk feature library.

14. The system according to claim 12, characterized in that, the suspicious behavior detection logic is an approach of performing a security detection on the application program by utilizing a suspicious behavior library.
